(19) United States
(12) Patent Application Publication
(10) Pub. No.: US 2026/0288923 A1
(43) Pub. Date: Sep. 24, 2026

(54) SECURE STORAGE SYSTEM BASED ON BIOMETRIC IDENTIFICATION

(71) Applicant: 0101 Technology Co., Ltd., Shenzhen (CN)

(72) Inventor: Jianquan Wen, Meizhou (CN)

(21) Appl. No.: 19/463,884

(22) Filed: Jan. 29, 2026

(30) Foreign Application Priority Data
Mar. 21, 2025 (CN) 202510340012.7

(51) Int. Cl. G06F 21/32

(52) U.S. Cl. CPC G06F 21/32

(57) ABSTRACT

A secure storage system based on biometric identification includes: a user instruction system module: used for users to issue instruction media; a single-chip microcomputer control center module: used to retrieve information from a user privacy carrier module for collection, verification, and management, and provide relevant instructions and status displays; a storage medium module: used to store user information; a resetter module: when the user's biometric features are damaged or lost, it resets the encrypted stored information and re-collects personal data; a product status system module: used to inform users of the current status of the product. The system realizes hardware upgrading, eliminates the need for network connection, application software, and keyboard-based operations. This not only simplifies user operations and enables localized management of users' biometric features but also ensures the encryption and decryption of the storage medium, as well as the subsequent localized management of users' biometric features.

### TECHNICAL FIELD

The invention relates to the technical field of secure data storage, and particularly to a secure storage system based on biometric identification.

### BACKGROUND ART

With the rapid development of big data, artificial intelligence, and Internet technologies, the core data of individuals and enterprises is facing severe network security risks. To effectively ensure the security of sensitive information assets, the adoption of hardware-level encrypted storage devices has become an essential solution for modern digital privacy protection.

Currently, for encrypted storage, the technical forms of such products include fingerprint-encrypted storage managed by computer software, fingerprint-encrypted storage managed by mobile APP software, and fingerprint-encrypted storage managed by both computer software and mobile APP software. Additionally, some products incorporate a keyboard-based password method to achieve encrypted storage. As big data, artificial intelligence, and Internet technologies continue to develop rapidly, the core data of individuals and enterprises is confronting severe network security hazards. Consequently, the use of hardware-level encrypted storage devices has become a necessary solution for safeguarding modern digital privacy and protecting sensitive information assets.

The encrypted storage methods in the prior art have many shortcomings. For fingerprint-encrypted storage, users are required to download and install application software and learn to use it, which involves multiple operation steps, slow speed, and high likelihood of failure. Moreover, the transmission of fingerprint data is prone to errors and risks of theft, and fingerprint wear may even render the product obsolete. For password-encrypted storage, the matrix keyboard often leads to poor contact of connectors; the password setup is complicated; the small keys are prone to misoperation; the product is large in size and inconvenient to carry; and forgetting the password may result in data loss.

### SUMMARY OF THE INVENTION

The main objective of the invention is to provide a secure storage system based on biometric identification, which can effectively solve the problem that fingerprint-encrypted storage and password-encrypted storage in the prior art cannot store information effectively.

To achieve the above objective, the technical solution adopted by the invention is: a secure storage system based on biometric identification, the system includes:
a user instruction system module: used for users to issue instruction media;
a single-chip microcomputer control center module: used to retrieve information from a user privacy carrier module for collection, verification, and management, and provide relevant instructions and status displays;
biometric identification model, configured to identify and acquire a user's biometric features, wherein said biometric features include: fingerprints, irises, retinas, facial features, and voice characteristics (voiceprints);
a storage medium module: used to store user information. a resetter module: when the user's biometric features are damaged or lost, it resets the encrypted stored information and re-collects personal data (the information includes but is not limited to face, fingerprint, and voice);
a product status system module: used to inform users of the current status of the product;
an interface system, for data transmission.

Preferably, the user instruction system module includes but is not limited to buttons, face, voice, touch screens, eye-tracking, brain-computer interfaces, handwriting, somatosensory, and optical markers.

Preferably, the single-chip microcomputer control center module serves as a control center, management center, algorithm center, data security encryption and data processing center, and communication mode control center of the entire product.

Preferably, the storage medium module includes but is not limited to USB drives, flash memory, solid-state storage, hard disks, and cloud storage; the information includes but is not limited to documents, photos, and videos.

Preferably, the resetter module is external to the main product body, exists independently, and is connected to the main product body through a communication method, the communication methods include but are not limited to wired connection, contact points, plugs, connectors, Bluetooth, WIFI, Near Field Communication (NFC), connection to other devices, cloud services, third-party software, and connection to other smart hardware.

Preferably, the product status system module informs users of the current status of the product through specific methods, which include but are not limited to physical indicator lights, screens, software interfaces, voice prompts, vibrations, mobile applications, specific icons, and text.

Preferably, the user privacy carrier module includes users' biometric features such as but not limited to fingerprints, irises, retinas, facial features, and voice features.

Preferably, an interface system includes two major categories: wired and wireless; wired interfaces include but are not limited to USB, TYPE-C, USB-C, Lightning, DP, miniDP, serial interfaces, and parallel interfaces; wireless interfaces include but are not limited to Ethernet, VGA, HDMI, audio interfaces, Wi-Fi, Bluetooth, NFC, mobile communications, infrared, radio frequency, and Internet of Things (IoT) connections.

Preferably, the instruction media include but are not limited to buttons, face, voice, touch screens, eye-tracking, brain-computer interfaces, handwriting, somatosensory, and optical markers.

Compared with the prior art, the invention has the following beneficial effects:
1. In the invention, the system is applied to the product itself. By adopting a user instruction system, a single-chip microcomputer control center module, a storage medium module, a resetter module, a product status system module, and a biometric feature module, it realizes hardware upgrading, eliminates the need for network connection, application software, and keyboard-based operations. This not only simplifies user operations and enables localized management of users' biometric features but also ensures the encryption and decryption of the storage medium, as well as the subsequent localized management of users' biometric features.
2. In the invention, the system collects and manages users' biometric features (such as fingerprints, irises, facial features, etc.), deeply integrates these unique biometric information with the storage medium, and uses these biometric features as keys for encryption and decryption to implement encryption and decryption operations on the storage medium. Thereby, a highly secure personal data storage and management system is constructed, ensuring that users' private storage media are effectively managed and protected. Only through legal biometric verification can the data in the storage medium be accessed and operated, which greatly improves the security and confidentiality of the data.
3. In the invention, the system adopts an external resetter that is separated from the main product. In the case of damage to the user's biometric features, this design prevents damage or loss of the user's data and files in the storage medium, and can also unlock or reset the product's biometric features while ensuring the continued use of the storage medium device. At the same time, the user's data and files in the storage medium will not be lost, which significantly enhances security.

### BRIEF DESCRIPTION OF ACCOMPANY DRAWINGS

FIG. 1 is a flow chart of the invention.

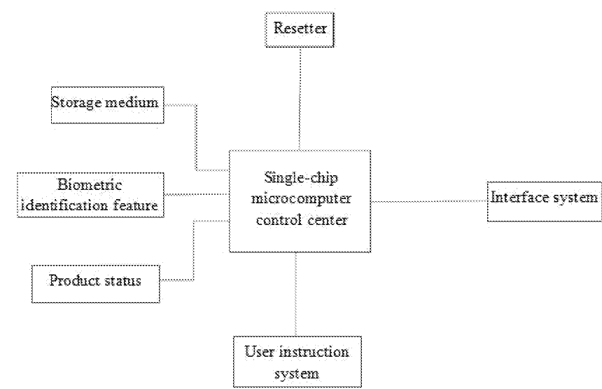

### SPECIFIC EMBODIMENT OF THE INVENTION

To make the technical means, creative features, objectives, and effects of the invention easy to understand, the invention will be further elaborated below in conjunction with specific implementation modes.

A secure storage system based on biometric identification, the system includes:
a user instruction system module: used for users to issue instruction media;
a single-chip microcomputer control center module: used to retrieve information from a user privacy carrier module for collection, verification, and management, and provide relevant instructions and status displays;
biometric identification model, configured to identify and acquire a user's biometric features, wherein said biometric features include: fingerprints, irises, retinas, facial features, and voice characteristics (voiceprints);
a storage medium module: used to store user information;
a resetter module: when the user's biometric features are damaged or lost, it resets the encrypted stored information and re-collects personal data (the information includes but is not limited to face, fingerprint, and voice);
a product status system module: used to inform users of the current status of the product. an interface system, for data transmission.

The user issues an operation instruction through the user instruction system module. after receiving the instruction, the single-chip microcomputer control center module retrieves information from the user privacy carrier module for collection, verification, and management, provides relevant instructions and status displays based on the verification results, and controls the storage medium module to encrypt, store, decrypt, or read user information. When the user's biometric features are damaged or lost, the resetter module intervenes to reset the encrypted stored information and re-collect personal data, ensuring the security and availability of user data; the product status system module informs the user of the current status of the product in real time, allowing the user to understand the operation progress and device conditions.

The user instruction system module includes but is not limited to buttons, face, voice, touch screens, eye-tracking, brain-computer interfaces, handwriting, somatosensory, and optical markers.

By integrating multiple user instruction input methods (such as buttons, face recognition, voice control, etc.), the flexibility and convenience of operation are greatly improved. Users can issue instructions based on the relevant biometric features (buttons, face, voice) set by the storage system. At the same time, this diversity enhances the system's compatibility and scope of application: whether using optical markers in a well-lit environment, relying on voice recognition in a noisy environment, or adopting cutting-edge technologies such as touch screens and eye-tracking, effective interaction between users and the device can be ensured. This meets the operation needs of different user groups (including users with special needs such as people with disabilities), optimizes the overall user experience, and enables the biometric-based secure storage system to operate stably in various complex environments and fully exert its secure storage function.

As the core of the biometric-based secure storage system, the single-chip microcomputer control center module has functions of control, management, algorithm execution, data encryption, processing, and communication control. It realizes efficient collection, verification, and management of users' biometric information, ensures secure encrypted storage and rapid processing of data, and at the same time achieves stable connection and data interaction with external devices through flexible communication control. This effectively improves the overall performance and security of the system and provides users with a convenient, secure, and reliable storage solution.

The storage medium module includes but is not limited to USB drives, flash memory, solid-state storage, hard disks, and cloud storage; the information includes but is not limited to documents, photos, and videos.

It provides users with a wide range of choices and flexible storage solutions, which can meet the diverse needs of different users in terms of storage capacity, read-write speed, portability, data security, and remote access. At the same time, it supports the storage of multiple types of information such as documents, photos, and videos, ensuring the secure storage and convenient management of various important data of users. This improves the practicality and applicability of the biometric-based secure storage system, enabling it to better adapt to data storage needs in different scenarios such as individuals and enterprises.

The resetter module is external to the main product body, exists independently, and is connected to the main product body through a communication method. The communication methods include but are not limited to wired connection, contact points, plugs, connectors, Bluetooth, WIFI, Near Field Communication (NFC), connection to other devices, cloud services, third-party software, and connection to other smart hardware.

It provides users with great flexibility and convenience: in special cases where the user's biometric features are damaged or lost, the user can easily reset the encrypted stored information through the resetter module and re-collect personal data without damaging or losing the data and files in the storage medium. This ensures the security of data and the availability of the storage system, effectively avoids the risk of data loss caused by biometric feature problems, and enhances users' trust in and reliance on the system.

The product status system module informs users of the current status of the product through specific methods, which include but are not limited to physical indicator lights, screens, software interfaces, voice prompts, vibrations, mobile applications, specific icons, and text. It provides users with comprehensive and intuitive product status feedback, allowing users to understand the operation status of the biometric-based secure storage system in real time (such as data storage, reading, encryption, decryption, and reset operations). This enhances users' controllability over product operations and their confidence in the product, and improves the user experience. At the same time, these diverse status prompt methods can also provide convenience for users in different environments and usage scenarios, ensuring that users can accurately obtain product status information even in complex or special environments, further guaranteeing the security and reliability of data storage and management.

The user privacy carrier module includes users' biometric features such as but not limited to fingerprints, irises, retinas, facial features, and voice features.

It enhances the security and reliability of the system: the integration of multiple biometric features not only reduces the risk of a single feature being cracked or forged but also meets the personalized needs of different users in different scenarios and improves the user experience. At the same time, it ensures that only authorized users can access the stored data, effectively protecting users' privacy and sensitive information.

An interface system includes two major categories: wired and wireless. Wired interfaces include but are not limited to USB, TYPE-C, USB-C, Lightning, DP, miniDP, serial interfaces, and parallel interfaces; wireless interfaces include but are not limited to Ethernet, VGA, HDMI, audio interfaces, Wi-Fi, Bluetooth, NFC, mobile communications, infrared, radio frequency, and Internet of Things (IoT) connections.

It provides the biometric-based secure storage system with a rich and diverse range of connection methods, enhancing the system's compatibility and scope of application. Users can perform data transmission and device connection according to the interfaces set by the storage system: whether it is a wired connection with common devices such as computers, mobile phones, and tablets, or remote interaction with smart devices through wireless methods such as Wi-Fi and Bluetooth, stable and efficient data transmission can be ensured. This meets the data storage and access needs of different users in different scenarios and improves the flexibility of the system and the user experience.

The instruction media include but are not limited to buttons, face, voice, touch screens, eye-tracking, brain-computer interfaces, handwriting, somatosensory, and optical markers.

It provides the biometric-based secure storage system with rich and diverse user interaction methods, greatly improving the flexibility and convenience of operation. Users can issue instructions according to the methods set by the storage system: whether through voice recognition in a noisy environment, optical markers in low light, or traditional methods such as touch screens and buttons, effective interaction between users and the system can be ensured. This meets the operation needs of different user groups (including users with special needs such as people with disabilities), optimizes the overall user experience, and enables the system to operate stably in various complex environments and fully exert its secure storage function.

The above descriptions show and explain the basic principles, main features, and advantages of the invention. Those skilled in the art should understand that the invention is not limited by the above embodiments. The above embodiments and the descriptions in the specification only illustrate the principles of the invention. Without departing from the spirit and scope of the invention, the invention will have various changes and improvements, and these changes and improvements all fall within the scope of the invention as claimed. The scope of protection claimed by the invention is defined by the appended claims and their equivalents.

1. A secure storage system based on biometric identification, the system includes:
a user instruction system module: used for users to issue instruction media;
a single-chip microcomputer control center module: used to retrieve information from a user privacy carrier module for collection, verification, and management, and provide relevant instructions and status displays;
biometric identification model, configured to identify and acquire a user's biometric features, wherein said biometric features include: fingerprints, irises, retinas, facial features, and voice characteristics (voiceprints);
a storage medium module: used to store user information;
a resetter module: when the user's biometric features are damaged or lost, it resets the encrypted stored information and re-collects personal data (the information includes but is not limited to face, fingerprint, and voice);
a product status system module: used to inform users of the current status of the product; and
an interface system, for data transmission.

2. The secure storage system based on biometric identification according to claim 1, wherein the user instruction system module includes but is not limited to buttons, face, voice, touch screens, eye-tracking, brain-computer interfaces, handwriting, somatosensory, and optical markers.

3. The secure storage system based on biometric identification according to claim 1, wherein the single-chip microcomputer control center module serves as a control center, management center, algorithm center, data security encryption and data processing center, and communication mode control center of the entire product.

4. The secure storage system based on biometric identification according to claim 1, wherein the storage medium module includes but is not limited to USB drives, flash memory, solid-state storage, hard disks, and cloud storage; the information includes but is not limited to documents, photos, and videos.

5. The secure storage system based on biometric identification according to claim 1, wherein the resetter module is external to the main product body, exists independently, and is connected to the main product body through a communication method, the communication methods include but are not limited to wired connection, contact points, plugs, connectors, Bluetooth, WIFI, Near Field Communication (NFC), connection to other devices, cloud services, third-party software, and connection to other smart hardware.

6. The secure storage system based on biometric identification according to claim 1, wherein the product status system module informs users of the current status of the product through specific methods, which include but are not limited to physical indicator lights, screens, software interfaces, voice prompts, vibrations, mobile applications, specific icons, and text.

7. The secure storage system based on biometric identification according to claim 1, wherein the user privacy carrier module includes users' biometric features such as but not limited to fingerprints, irises, retinas, facial features, and voice features.

8. The secure storage system based on biometric identification according to claim 1, wherein the interface system includes two major categories: wired and wireless; wired interfaces include but are not limited to USB, TYPE-C, USB-C, Lightning, DP, miniDP, serial interfaces, and parallel interfaces; wireless interfaces include but are not limited to Ethernet, VGA, HDMI, audio interfaces, Wi-Fi, Bluetooth, NFC, mobile communications, infrared, radio frequency, and Internet of Things (IoT) connections.

9. The secure storage system based on biometric identification according to claim 1, wherein the instruction media include but are not limited to buttons, face, voice, touch screens, eye-tracking, brain-computer interfaces, handwriting, somatosensory, and optical markers.
